(19) United States
(12) Patent Application Publication
(10) Pub. No.: US 2008/0170227 A1
(43) Pub. Date: Jul. 17, 2008

(54) Apparatus and Method for Determining Anisotropies Using Optical Microscopy

(76) Inventors: Thomas Schimming, Ireising (DE); Klaus Rink, Altdorf (DE)

Correspondence Address: OCTAX Microscience GmbH;c/o Dr. Thomas Schimming, Opalstr. 32, Altdorf, D-84032, omitted

(21) Appl. No.: 11/883,821

(22) PCT Filed: Jan. 19, 2006
(86) PCT No.: PCT/DE2006/000070

§ 371 Date: Aug. 6, 2007

(30) Foreign Application Priority Data
Feb. 7, 2005 (DE) 10 2005 005 757.8

(51) Int. Cl. G01J 4/00

(52) U.S. Cl. 356/364

(57) ABSTRACT

The present invention relates to an apparatus and a method for determining anisotropies affecting the polarization properties of light in microscopically small objects using optical microscopy. In particular, the invention relates to an apparatus comprising an optical path extending between a light source and an optical sensor, wherein the object, or specimen, is placed in this optical path. The optical path also includes an element for polarization analysis and at least one element adjustable by a controller, the at least one adjustable element causing a rotation of the polarization properties of light passing through said element, wherein the rotation is controllable with respect to its angle. A controller module of the apparatus applies at least three different rotation angles and acquires an image of the object for each of the at least three different rotation angles using the optical sensor. The apparatus is configured to allow images of an isotropic object region to be substantially constant for all rotation angles.

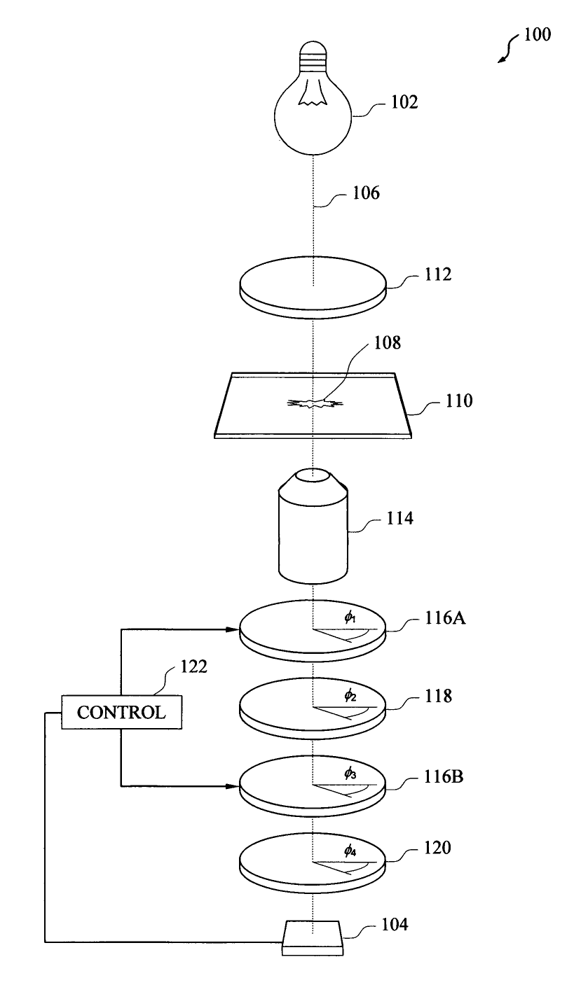

### PRIORITY

The present application is a national stage filing of PCT application PCT/DE2006/000070 filed Jan. 19, 2006, which claims priority from a German patent application 10 2005 005 757.8 filed Feb. 7, 2005.

### RELATED INFORMATION

The present invention relates to an apparatus and a method for determining, using optical microscopy, anisotropies affecting the polarization properties of light in microscopically small objects. In particular, the present invention relates to an apparatus for microscopically analyzing biological cells and the anisotropies thereof.

Determining anisotropies in microscopically small objects is, for example, of interest in the field of microbiology, in particular since the genetic information of biological cells results in anisotropic cell regions under favorable conditions.

Anisotropies are generally determined by determining changes in properties in the optical path from a light source across or through an object to be analyzed, or specimen, to an image sensor using elements which also influence the polarization properties of light and whose parameters are electrically adjustable. Suitable adjustable elements are, for example, liquid crystal cells.

By creating several images of an object to be analyzed with different light path configurations, in addition to the geometric distribution of transparency of the object in a selected plane (focal plane) obtained using classical light microscopy, enough information is provided to determine the geometric distribution of the optical anisotropy (and the optical retardation in particular) of the object in the same plane.

Minimal anisotropies pose a particular technical problem in the field of microbiology since a high degree of accuracy is required in this field.

Polarization microscopy and its application to microbiology are well known in the art. In conventional methods, the modification of the optical path is accomplished by means of mechanical modification (mostly rotation) of suitable elements, either driven by hand or by motor(s). A system not depending on mechanical motion is described in U.S. Pat. No. 5,521,705. The system disclosed therein preferably uses liquid crystal cells having a voltage dependent variable optical retardation.

Anisotropy is typically characterized by the parameter “optical retardation”. Optical retardation is defined as the phase shift between the x and y components of polarized light after passing through an anisotropic material, i.e. a material having a directionally dependent refraction index. The optical retardation is extracted manually, or by using image processing based on several microscopic images of the object to be analyzed, taken in different optical path configurations. From a mathematical model it can be observed that at least three images of the object in different optical path configurations are required to determine all parameters of interest: the local transparency of the object and the anisotropy, characterized by its angle of orientation in the image plane and its absolute value, most commonly measured in nanometers.

In practice, the known systems reveal certain inadequacies which in particular prevent analysis of moved or moving objects. The analysis of anisotropies of moved/moving objects requires that the at least three images of the object in different light path configurations be created in rapid succession. Such measurement cycle, or analysis cycle, should execute fast enough to allow the moved/moving objects to be considered approximately immovable, or stationary, during the cycle.

In known systems, the variable optical path configuration does not provide the necessary invariance for isotropic objects or isotropic object regions. However, isotropic regions, i.e. object regions showing no anisotropic behavior, make up large portions of the image and therefore the lack of invariance leads to a disturbing flickering, i.e. the brightness of the microscopic image changes cyclically. This in turn drastically impedes the use of image sensors for automatically acquiring and evaluating the images of the object since the varying brightness (i.e. the flickering) has to be compensated using computational methods which inevitably lead to signal-to-noise ratio degradation. Further, commonly used image sensors having adaptive brightness control cannot be utilized either as their brightness control is unable to follow the rapid flickering.

### OBJECTS & SUMMARY OF THE INVENTION

It is therefore an objective of the present invention to provide a novel apparatus and method for determining anisotropies.

It is further an objective of the present invention to provide a novel apparatus and method for determining anisotropies using optical microscopy.

It is a further objective to provide a novel apparatus and method for determining anisotropies in microscopically small objects allowing the determination of anisotropies of moving or moved objects.

In accordance with the foregoing objectives, the present invention provides, in accordance with claim 1, an apparatus for determining anisotropies using optical microscopy. An apparatus in accordance with the invention comprises an optical path extending between a light source and an optical sensor, wherein the object is placed in this optical path. The optical path also includes an element for polarization analysis and at least one element adjustable by a control, the at least one adjustable element causing a rotation of the polarization properties of light passing through said element, wherein the rotation is controllable with respect to its angle. A controller module of the apparatus comprises means for applying at least three different rotation angles and means for acquiring an image of the object for each of the at least three different rotation angles using the optical sensor. The apparatus is configured to allow images of an isotropic object region to be substantially constant for all rotation angles.

Preferably, a light source can be provided which emits substantially monochromatic circularly polarized light.

In a variation on the invention, a linear polarizing filter is used as element for polarization analysis.

For providing three rotation angles, a single adjustable element can be provided, which can be adjusted to any one of at least three different rotation angles when controlled accordingly. Preferentially, an element allowing for rotation angles of 020 , 6020 , and 120° or 0° , 12020 , and 24020 is used.

Instead of a single element having three angle states two elements each having two rotation angle states can be provided such that by controlling the two elements a total of at least three different rotation angles can be achieved. Preferably, elements having rotation angles of 020 and 6020 , or 020 and 12020 are then used. These elements are then arranged such that by controlling the two elements at least three different resulting rotation angles of approximately 020 , 60°, and 12020 or 0°, 12020 , and 24020 can be adjusted.

In an optimal arrangement adjustable elements are used that are configured to have no optical retardation or an optical retardation equal to an integer multiple of the wavelength of the light emitted by the light source.

In another arrangement adjustable elements are used that cause a rotation by a rotation angle and an optical retardation in their non-excited state, and approximately no rotation and approximately no retardation in their excited state.

Additionally, an optical compensation element such as a retardation element may be included in the optical path, the parameters of which, e.g. retardation and mounting angle, are selected with respect to the adjustable elements such that images of an isotropic object region do not vary substantially for the resulting rotation angles. This retardation element is preferably placed in the optical path between the adjustable elements. Advantageously, adjustable elements having a rotation angle in their non-excited state of approximately 9020 can be used. Such elements are inexpensive and available from several manufacturers.

Suitable for use as adjustable elements are for example TN (twist nematic) liquid crystal cells, as these cells change state quick enough, to allow an acquisition at a frame rate of 10-50 images per second and thus allow anisotropy determination of moved or moving objects.

The present invention also provides a method for determining the isotropic properties of an object using a microscopy apparatus, comprising the following steps:
providing at least one light source;
providing an optical sensor;
providing an optical path extending between the light source and the optical sensor, the object being placed in the optical path;
providing at least one element in the optical path for a polarization analysis;
providing at least one element in the optical path adjustable by a controller, the at least one adjustable element causing a rotation of the polarization properties of light passing through said element, wherein the rotation is controllable with respect to its angle;
applying one of at least three different rotation angles by said controller;
acquiring an image of the object for each of the at least three different rotation angles by means of the optical sensor;
   wherein said microscopy apparatus is configured to allow images of an isotropic object region to be substantially equal for all rotation angles.

Advantageous embodiments of the inventive method are provided in the dependent method claims.

An advantage is that the different (at least three) images of the object to be analyzed taken in different optical path configurations show no or only minimal differences in brightness for object areas without anisotropies, i.e. isotropic object areas, such that an image representation (in an ocular of the microscope as well as on the image sensor) is not different or only minimally different from a conventional microscopic image representation outside potentially anisotropic regions.

Another advantage of a system having such invariance is that a substantially constant brightness can be maintained over time, in particular when biological cells having large isotropic object regions are analyzed using the microscope. This constant brightness, or luminosity, is useful for an automatic time-independent adjustment of the image sensor to the illumination, which in turn guarantees an optimal precision, and in particular a high signal-to-noise ratio, for the image acquisition. Constant brightness is further of advantage when using commonly available image sensors with built-in adaptive brightness control since their adaptive control techniques are designed for quasi-static, i.e. only slowly changing, illumination environments.

### BRIEF DESCRIPTION OF THE DRAWINGS

These and other advantages will be better understood with reference to the following exemplary FIGURE. The FIGURE shows an embodiment the present invention.

### DETAILED DESCRIPTION OF THE PREFERRED EMBODIMENTS

Embodiments of the present invention will now be described in detail with reference to a drawing.

The FIGURE shows by way of schematic diagram a microscopy apparatus 100 having a light source 102 and an optical sensor 104. Also shown is an optical path 106 extending between light source 102 und sensor 104. An object, or specimen, 108 to be analyzed by microscopy is typically placed in the optical path 106 on an object holder 110. Microscopy apparatus 100 will in practice often also comprise an objective 114.

It is of advantage if the object 108 to be analyzed is illuminated by suitably polarized light which is time-invariant. One manner in which this may be achieved is to illuminate object 108 using circular polarized light, which is obtained by placing a circular polarizing filter 112 in the optical path between light source 102 of the microscope and object 108. A mathematic model analysis of the problem shows that a complete analysis of the anisotropies independent of their orientation in the focal plane is possible when using circular polarized light for illumination purposes.

An apparatus that is invariant, i.e., exhibiting constant brightness, for isotropic object regions and which provides a constant brightness is achieved by placing one or more elements 116 into optical path 106 between object 108 and sensor 104 having the electrically adjustable ability to rotate the polarization properties of light in optical path 106.

Of particular advantage are adjustable elements 116 that have no optical retardation, or anisotropy, of their own. The advantage lies therein that those portions of the circular polarized light from light source 102 which remain unchanged by anisotropies in object 108, and thus are still circular polarized, are not measurably affected by rotation. A polarization analysis, which follows in optical path 106, will therefore have the desired invariance. Such polarization analysis may advantageously be performed using a linear polarizing filter 120.

A controller 122, for example a microprocessor or circuit element, is shown schematically in the FIGURE that provides for electrically controlling element(s) 116 and adjusting the rotation caused by element(s) 116 to a desired rotation angle. Controller 122 may be coupled with sensor 104 for acquiring an image using sensor 104 after adjusting a rotation angle, or for initiating such image acquisition.

Three images of the object are acquired using at least three different configurations in order to achieve an efficient quantization of anisotropies outside the invariant (i.e. isotropic) object regions. The different configurations are obtained by three different rotation angles. This can be accomplished by a single element 116A having three different rotation configurations or by two consecutive elements 116A, 116B each having two different rotation configurations. Three of the four constellations resulting from two elements may be selected.

If only a single element 116A is provided, controller 122 provides one of three different voltages corresponding to the three different optical rotation angles of element 116A. If, on the other hand, two elements 116A, 116B are provided, controller 122 provides one of two voltages corresponding to one of the two rotation angles to each of the elements 116A, 116B in order to adjust a desired one of the three resulting rotation angles. The voltage may be applied by any suitable voltage device well known to the skilled person in the art.

Suitable inexpensive elements that effect a rotation of the polarization properties of light are so called TN (twist-nematic) liquid crystal cells, the liquid crystal of which effects a rotation of the polarization properties of light in an inactive state. In such cells, the rotation angle can be prescribed during assembly. By way of suitable design it is further possible to suppress anisotropic properties of the TN cells for certain wavelengths of the light used. The optical retardation in this case reaches an integer multiple of the wavelength and is therefore not detectable, or measurable. This can be ensured by a suitable color filter or interference filter having a narrow wavelength pass window into the optical path directly following light source 106.

By applying an electrical voltage as controlled by controller 122 it is possible to toggle these TN liquid crystal cells to an isotropic state in which—at least in good approximation—neither a rotation nor an optical retardation occurs. Additionally, the transition from inactive to active state (and vice versa) is possible in particularly short time for such TN liquid crystal cells. In particular, TN liquid crystal cells are substantially faster than those liquid crystal cells known from above-referenced U.S. Pat. No. 5,521,705 which rely on electrically adjusting the optical retardation and for which no rotation occurs. The transition times of TN liquid crystal cells allow a pseudo moving image analysis having frame rates on the order of 10-50 frames per second which cannot be achieved at the necessary precision using liquid crystal cells used heretofore due to their substantially slower electrical controllability.

From a mathematical model of microscopy apparatus 100 it follows that an apparatus may be optimized utilizing two adjustable elements 116A, 116B, each being toggleable between a rotation of 6020 and a rotation of 020 , placed consecutively in optical path 106 between object 108 and sensor 104, followed by a linear polarizer 120 having an arbitrary orientation.

For object analysis, three configurations may be used: (a) rotation of 6020 in the first element and 6020 in the second element, (b) rotation of 6020 in the first element and 020 in the second element, (c) rotation of 020 in the first element and 020 in the second element. The same result, for example, can be obtained using elements 116A, 116B having a rotation of 12020 and 020 instead of 6020 and 020 . Other configurations are clearly within the scope of the invention.

Through the image sensor 104 following in optical path 106 an image is acquired for each of the configurations (a) to (c). If anisotropies are present, then the brightness information is determined as the average value of the three acquired images. The degree of the anisotropy, i.e. the local optical retardation, is determined from the difference images (a) and (b), or (b) and (c), respectively. This may be obtained by a subtraction of the image data in a digital image processing system (not shown) from the three raw images. Of course, other difference algorithms may be utilized.

An advantage of this arrangement is an angle-independent determination of the degree of anisotropy directly from the difference images using few mathematical operations. This may be usefully, for example, executed in real-time on present-day commercially available computer image analysis systems at, for example, 10-50 images per second. It shall be noted that in the case of small anisotropies—which are typical for the field of microbiology—the measurement accuracy can be improved even further by using a temporal moving average of the calculated difference images as the expected object movement is relatively slow without degrading the correct temporal representation of isotropic portions of the resulting image.

Such TN liquid crystal elements having a rotation of 60° or 12020 and no optical retardation in the inactive state, while technically feasible, are uncommon and may require expensive custom manufacturing. By contrast, TN liquid crystal elements having a rotation of 90° may also be used. The latter are readily available since such cells allow for the unproblematic and wavelength-independent manufacturing of optical valves (so called shutters). Such elements, however, can normally not be assumed to have a suitable optical retardation in the inactive state that causes the anisotropy to disappear. Rather, it will often be necessary to measure the optical retardation for each such element in order to fully optically characterize the element. However, it is guaranteed for such commercially available elements having a rotation of 9020 that in their electrically active state, i.e. after applying a sufficiently high voltage by means of controller 122, the rotation as well as the optical retardation will vanish, at least approximately. Other rotations which diminish optical retardation are also within the scope of the invention although not explicitly mentioned here.

In order to ensure the advantageous invariance with such 90°-Elements 116, and to achieve an optimal analysis performance (measurement accuracy), optical apparatus 100, which in its optical path 106 may be configured to include light source 102, color filter (not shown), circular polarization filter 112, object 108 to be analyzed, first TN liquid crystal element 116A, second TN liquid crystal element 116B, linear polarization filter 120 and image sensor 104 needs to be suitably compensated by an optical compensation element 118 in order to facilitate three configurations with at least near-identical images of isotropic objects or isotropic object regions. Such compensation can for example be accomplished by inserting a suitable, preferably fixed optical retardation element 118 having a prescribed, commercially available retardation into optical path 106 between first TN liquid crystal element 116A and second TN liquid crystal element 116B.

It is advised to optimize as free parameters the relative orientation angles between the different components of system 100 contributing to the optical analysis (first TN liquid crystal element 116A, retardation element 118, second TN liquid crystal element 116B, linear polarization filter 120). Of course a compound compensation element comprising two or more—for example sandwiched—Elements, or a group of elements, may be provided instead of a single compensation element 118 without departing from the present invention.

An example of the parameters of the optical apparatus may include the following. For commercially available 9020 TN liquid crystal cells 116A, 116B for which φ₁=φ₃=0°/9020 and having a specific optical retardation of 105 nm with an retardation angle orientation of 2020 and which are mounted with a relative orientation angle of 0° to each other, an optimal compensation can be achieved using a commercially available 140 nm retardation element 118 if it is mounted with a relative angle of φ₂=−3° with respect to liquid crystal cells 116A, 116B and linear polarizer 120 is mounted with a relative angle of φ₄=10° with respect to liquid crystal cells 116A, 116B. Calculating the relevant orientation angles as functions of the parameters of liquid crystal cells 116A, 116B (rotation angle and absolute value and orientation angle of optical retardation) and the absolute value of optical retardation of compensation element 118 is unproblematic by modeling optical path 106 mathematically using the Mueller matrix method which is suitable for polarization optical calculations, and by then approximating the desired properties of entire system 100 by determining the four free parameters (relative angles between said elements, in the FIGURE schematically shown as angles φ₁ . . . φ₄) using numerical optimization methods.

In operation, it is advisable to take into account the following optimization criteria: deviation from a desired invariance for a given parameter set in the three relevant configurations (to be minimized); and difference of absolute values when calculating the difference for a given anisotropy of the object (in different angle configurations; to be maximized). Generally, a good invariance can be achieved, however the angle dependency of the anisotropy determination may be less favorable compared to a system using 60° or 12020 elements, but still sufficient for practical applications. The numerical optimization can further be improved by determining the exact optical properties Of TN liquid crystal cells 116A, 116B in the active (voltage carrying) state; however the assumption of a 020 rotation and a 0 nm optical retardation may already lead to satisfactory results.

It shall be noted that placing compensation element 118 between adjustable elements 116 is only one of numerous placement options. Said element may be placed in different locations in the optical path such as between object and first adjustable element 116A or between second adjustable element 116B and sensor 104. It is further possible to incorporate analysis element 120 and compensation element into a single element—not shown.

It shall further be noted that an apparatus in accordance with the present invention may include additional active or passive optical elements in optical path 106 that, for example, serve to improve optical path 106, protect object 108 from excessive heat, magnify, or improve sharpness of the images. On the other hand, as suitable high resolution sensors 104 having a sufficient imaging performance become available, magnifying optical elements such as objective 114 may be omitted.

A semitransparent sensor 104 followed by an ocular (not shown) can also be provided in order to allow a user of the apparatus to control the image acquired by the sensor. Alternately a prism or the like can by provided in the optical path for splitting the optical path into an optical path to the sensor and an additional optical path to an ocular—not shown. For better color reproduction, the optical path may be split into the three color components red, green, and blue by prisms and a separate sensor may be provided for each of these primary colors—not shown.

Finally it shall be noted that applications of the inventive apparatuses are conceivable that require more than three different polarization configurations. A multitude of such configurations can be obtained by providing an arbitrary number of rotation angles, either by a single element being adjustable to a multitude of rotation angle states or by suitably combining elements each, for example, having two or three states.

Thus, the invention is not limited to any specific example enumerated herein, but includes all variants and modifications that embody the spirit and scope of the present invention.

What is claimed is:

1. Apparatus for determining the isotropic properties of an object using optical microscopy, the apparatus comprising:
at least one light source;
an optical sensor;
an optical path extending between the light source to the optical sensor, the object being placed in the optical path;
at least one element in the optical path for a polarization analysis;
at least one adjustable element in the optical path adjustable by a controller, the at least one adjustable element causing an optical rotation of the polarization properties of light passing through said adjustable element, wherein the rotation is controllable with respect to its angle;
means for applying at least three different optical rotation angles;
wherein the optical sensor acquires an image of the object for each of the at least three different optical rotation angles; and
wherein the apparatus is configured such that a brightness of isotropic regions of the images remains substantially identical for all rotation angles.

2. The apparatus of claim 1, wherein the light source emits substantially monochromatic circularly polarized light.

3. The apparatus of claim 1, wherein the element for polarization analysis is a linear polarizing filter.

4. The apparatus of claim 1, wherein a single adjustable element is provided which can be adjusted to any one of at least three different optical rotation angles, two of which differ by approximately 6020 or approximately 12020 from the third.

5. The apparatus of claim 1, wherein two adjustable elements are provided in the optical path, wherein each of the two adjustable elements has two optical rotation angle statuses and wherein the two adjustable elements are arranged such that at least three different optical rotation angles can be achieved by controlling the adjustable elements.

6. The apparatus of claim 5, wherein each of the adjustable elements has a first optical rotation angle status and a second optical rotation angle status which differs by approximately 6020 or approximately 12020 from the first and wherein the adjustable elements are arranged such that controlling the two adjustable elements yields at least three resulting optical rotation angles, two of which differ by approximately 6020 or approximately 12020 from the third.

7. The apparatus of claim 2, wherein the adjustable elements are configured to have no optical retardation or an optical retardation equal to an integer multiple of the wavelength of the light emitted by the light source.

8. The apparatus of claim 5, wherein each of the adjustable elements cause an optical rotation by a rotation angle and an optical retardation in their non-excited state, and approximately no optical rotation and approximately no retardation in their excited state and wherein an additional optical compensation element is included in the optical path, the parameters of which are selected with respect to the adjustable elements such that images of an isotropic object region remain substantially identical for each of the resulting rotation angles.

9. The apparatus of claim 8, wherein the optical compensation element is a retardation element which is placed in the optical path between the adjustable elements.

10. The apparatus of claim 8, wherein the adjustable elements have an optical rotation angle in their non-excited state of approximately 9020 .

11. The apparatus of claim 1, wherein the at least one adjustable element comprises a TN liquid crystal element.

12. Method for determining the isotropic properties of an object using a microscopy apparatus, comprising the following steps:
providing at least one light source;
providing an optical sensor;
providing an optical path extending between the light source to the optical sensor;
placing an object in optical path;
selecting at least one element for a polarization analysis;
selecting at least one adjustable element whose optical rotation is adjustable;
adjusting the adjustable element to cause an optical rotation of the polarization properties of light passing through said adjustable element, wherein the rotation is controllable with respect to its angle;
applying one of at least three different optical rotation angles by a controller;
acquiring an image of the object for each of the at least three different optical rotation angles by means of the optical sensor; and
configuring said microscopy apparatus such that a brightness of isotropic regions of the images remains substantially identical for all rotation angles.

13. The method of claim 12, wherein the light source emits substantially monochromatic circularly polarized light.

14. The method of claim 12, wherein a single adjustable element is provided and wherein the step of configuring adjusts the optical rotation angles to any one of at least three different optical rotation angles, two of which differ by approximately 6020 or approximately 12020 from the third.

15. The method of claim 12, wherein two adjustable elements are provided in the optical path, wherein each of the two adjustable elements has two optical rotation angle statuses and wherein the two adjustable elements are arranged such that at least three different optical rotation angles can be achieved by controlling the adjustable elements.

16. The method of claim 15, wherein the step of configuring configures each of the adjustable elements to have a first optical rotation angle status and a second optical rotation angle status which differs by approximately 6020 or approximately 12020 from the first and such that controlling the two adjustable elements yields at least three resulting optical rotation angles, two of which differ by approximately 6020 or approximately 120° from the third.

17. The method of claim 12, wherein the step of selecting an adjustable element selects an element that causes no optical retardation or cause an optical retardation equal to an integer multiple of the wavelength of the light emitted by the light source.

18. The method of claim 15, wherein the step of selecting the adjustable elements selects adjustable elements that cause an optical rotation by an optical rotation angle and an optical retardation in their non-excited state, and approximately no optical rotation and approximately no retardation in their excited state and wherein an additional optical retardation element is included in the optical path, the parameters of which are selected with respect to the adjustable elements such that images of an isotropic object region remain substantially equal for each of the resulting rotation angles.

19. The method of claim 18, wherein the step of selecting adjustable elements selects adjustable elements having a rotation angle in their non-excited state of approximately 90°.

20. Apparatus for determining the isotropic properties of an object using optical microscopy, the apparatus comprising:
at least one adjustable element causing an optical rotation of the polarization properties of light passing through the adjustable element having a total of at least three different optical rotation angles; and
wherein each of the three different optical rotation angles for the at least one adjustable element is configured such that a brightness of isotropic regions of the images remains substantially identical.
